(19) United States
(12) Patent Application Publication
(10) Pub. No.: US 2003/0210764 A1
(43) Pub. Date: Nov. 13, 2003

(54) Pulsed power application for x-ray tube

(76) Inventors: Kasegn Dubale Tekletsadik, New Berlin, WI (US); John Scott Price, Wauwatosa, WI (US)

Correspondence Address: CANTOR COLBURN, LLP, 55 GRIFFIN ROAD SOUTH, BLOOMFIELD, CT, 06002

(21) Appl. No.: 10/063,763

(22) Filed: May 10, 2002

(51) Int. Cl. H05G 1/22

(52) U.S. Cl. 378/106

(57) ABSTRACT

A system and method for providing pulsed power application for an x-ray tube that comprises an x-ray tube having an anode and cathode; and a power supply adapted to provide an anode-to-cathode gap voltage, wherein the gap voltage is pulsed during x-ray exposure resulting in a pulsed x-ray radiation.

### BACKGROUND OF INVENTION

The x-ray tube has become essential in medical diagnostic imaging, medical therapy, and various medical testing and material analysis industries. Typical x-ray tubes are built with a rotating anode structure that is rotated by an induction motor comprising a cylindrical rotor built into a cantilevered axle that supports the disc shaped anode target, and an iron stator structure with copper windings that surrounds the elongated neck of the x-ray tube that contains the rotor. The rotor of the rotating anode assembly being driven by the stator which surrounds the rotor of the anode assembly is at anodic potential while the stator is referenced electrically to ground. The x-ray tube cathode provides a focused electron beam which is accelerated across the anode-to-cathode vacuum gap and produces x-rays upon impact with the anode target. The target typically comprises a disk made of a refractory metal such as tungsten, molybdenum or alloys thereof, and the x-rays are generated by making the electron beam collide with this target, while the target is being rotated at high speed. High speed rotating anodes can reach 9,000 to 11,000 RPM.

Only a small surface area of the target is bombarded with electrons. This small surface area is referred to as the focal spot, and forms a source of x-rays. Thermal management is critical in a successful target anode, since over 99 percent of the energy delivered to the target anode is dissipated as heat, while significantly less than 1 percent of the delivered energy is converted to x-rays. Given the relatively large amounts of energy which are typically conducted into the target anode, it is understandable that the target anode must be able to efficiently dissipate heat. The high levels of instantaneous power delivered to the target, combined with the small size of the focal spot, has led designers of x-ray tubes to cause the target anode to rotate, thereby distributing the thermal flux throughout a larger region of the target anode.

When considering the performance of x-ray tubes, some of the issues of importance are x-ray generation efficiency, patient dose management, high voltage stability, selective spectral content, detector response time and speed of image acquisition.

Current x-ray tube design has an efficiency of around 1 percent. Most of the power input is dissipated as heat. Handling thermal problems is one of the challenges facing X-ray tube designers, who are trying to design high power tubes. Any method, which brings improvement to the efficiency of the x-ray generation, would be extremely important. The current practice uses a DC power supply for anode-to-cathode voltage and produces DC emission current, which in turn generates DC x-radiation output. With the present method, there are times where the x-ray is generated and not used for image production, i.e., there are time intervals where x-ray is not required.

Thus, a method and apparatus is desired to eliminate unnecessary photon generation when the photons are not needed or have a minimum effect on image quality based on the detector response time or the speed of image acquisition. Thus, it is desirable to synchronize x-ray radiation output with image recording to reduce unnecessary emission of x-ray radiation.

### SUMMARY OF INVENTION

The above discussed and other drawbacks and deficiencies are overcome or alleviated by a pulsed power application system for an x-ray tube that comprises an x-ray tube having an anode and cathode; and a power supply adapted to provide an anode-to-cathode gap voltage, wherein the gap voltage is pulsed at a frequency well above traditional gridding and so-called primary contact pulsing frequencies during x-ray exposure resulting in a pulsed x-ray radiation.

In an alternative embodiment, a method to improve the efficiency of operation in x-ray tubes is disclosed. The method includes connecting a high voltage supply to the x-ray tube having an anode and a cathode disposed in the x-ray tube to provide a gap voltage therebetween; pulsing said gap voltage at a frequency well above traditional gridding and so-called primary contact pulsing frequencies during x-ray exposure; and generating a pulsed x-ray radiation from said anode.

The above discussed and other features and advantages of the present invention will be appreciated and understood by those skilled in the art from the following detailed description and drawings.

### BRIEF DESCRIPTION OF DRAWINGS

Referring to the exemplary drawings wherein like elements are numbered alike in the several Figures:

FIG. 1 illustrates a high level diagram of an x-ray imaging system;

FIG. 2 is a schematic illustration of an exemplary embodiment of a pulsed power supply including an electron source and a grid circuit in operable communication with an x-ray tube for generating pulsed x-ray radiation;

FIG. 3 is a graph illustrating current practice of DC x-ray generation plotting DC voltage, DC current and energy input; and

FIG. 4 is a graph of pulsed x-ray generation plotting DC voltage, pulsed current and energy input using the pulsed power supply of FIG. 2.

### DETAILED DESCRIPTION

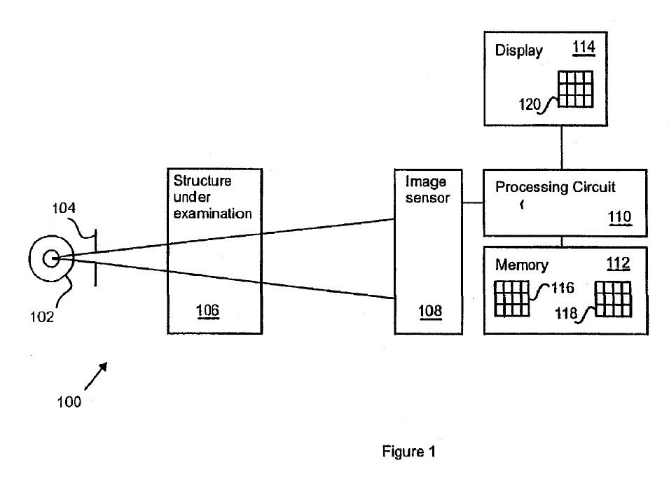

Turning now to FIG. 1, that figure illustrates an x-ray imaging system 100. The imaging system 100 includes an x-ray source 102 and a collimator 104, which subject structure under examination 106 to x-ray photons. As examples, the x-ray source 102 may be an x-ray tube, and the structure under examination 106 may be a human patient, test phantom or other inanimate object under test.

The x-ray imaging system 100 also includes an image sensor 108 coupled to a processing circuit 110. The processing circuit 110 (e.g., a microcontroller, microprocessor, custom ASIC, or the like) couples to a memory 112 and a display 114. The memory 112 (e.g., including one or more of a hard disk, floppy disk, CDROM, EPROM, and the like) stores a high energy level image 116 (e.g., an image read out from the image sensor 108 after 110-140 kVp 5 mAs exposure) and a low energy level image 118 (e.g., an image read out after 70 kVp 25 mAs exposure). The memory 112 also stores instructions for execution by the processing circuit 110, to cancel certain types of structure in the images 116-118 (e.g., bone or tissue structure). A structure cancelled image 120 is thereby produced for display.

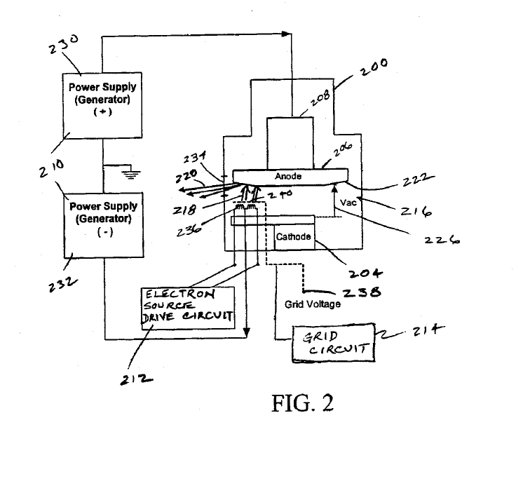

Referring to FIG. 2, an x-ray tube 200 for use as x-ray source 102 is shown with a cathode 204, anode 206 and frame 208 having a dielectric insulator shown generally at 216, all of which are disposed inside X-ray tube 200. FIG. 2 also illustrates exemplary components that control the x-ray exposure; a main power supply (generator) 210, power supply for the filaments or an electron source 212, and a grid circuit 214. The power supply generator 210, electron source 212, and grid circuit 214 can be used individually or in combination to generate a pulsed power input to x-ray tube 200. A method using a combination of the above exemplary components is outlined below.

In an exemplary method, pulsed tube emission current 218 is generated, which in turn generates pulsed x-ray radiation 220 from an anode target 222. The frequency, pulse width, and duty cycle of the pulsed emission current 218 is determined by the response time of the x-ray detectors, image acquisition speed and by requisite image quality.

For a current pulse of frequency (f), pulse ON-time (T_{ON}) pulse OFF-time (T_{OFF}) and period (T), the Efficiency Improvement Factor is;

$$\frac{{T}_{ON} + {T}_{OFF}}{{T}_{ON}}$$

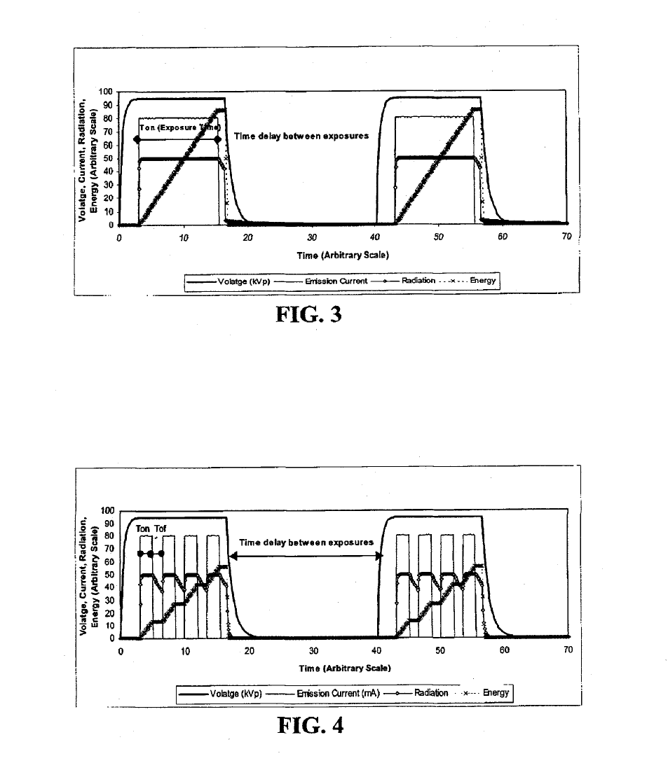

FIG. 3 illustrates the principle of x-ray generation when the duty cycle is 100% (T_{OFF}=0). More specifically, FIG. 3 illustrates a DC voltage, DC current, DC x-ray radiation and energy input when the emission current is not pulsed as compared with FIG. 4.

Referring briefly to FIG. 4, for a pulse of emission current 218 with a 50% duty cycle (T_{ON}=T_{OFF}), the efficiency improvement factor would be 2, i.e., a 100% efficiency gain over the conventional method. It will be recognized that the efficiency improvement factor is optionally interpreted as an input power reduction factor.

For instance, a CT (Computed Tomography) scanner takes 500 μs for image acquisition, and scans at a 600 μs interval. Thus, there is a time period of 100 μs within the 600 μs interval that x-ray photons are still generated but not used, which means that if a pulsed emission current 218 was used the input power would have been reduced by a factor of 16.7% (e.g.,=100/600).

The exemplary methods disclosed herein assume that the human body dynamics would not change significantly in a sub-millisecond time scale. And as a result of any change in human body dynamics, any loss of image for microseconds would not affect the diagnostic procedure. With this basic assumption, producing pulsed x-ray radiation having a pulse frequency in the order of tens of kHz would not create significant loss of information. It is also assumed that the response time (especially the fall time) of x-ray detectors is slower than the response time of the emission current. In this case, x-ray signals decay at a much longer time constant and would keep their value at nearly their peak value until the next pulse arrives. FIG. 4 shows the expected voltage, current and x-ray radiation waveforms.

Still referring to FIG. 2, an exemplary method for generating a pulsed power input to x-ray tube 200 will be described. A main anode-to-cathode gap voltage 226 is pulsed at a high frequency by pulsing high voltage power supply 210. The duration of each pulse is preferably below about one millisecond. Emission current 218 and x-ray generation 220 is controlled by pulsing the extraction voltage Vac. Modern pulsed power supply generating equipment is becoming less complex and less costly. However, at higher voltages, typically about 150 kV and higher instantaneous power requirements, generating a pulsed power supply is a challenge. For a bipolar x-ray tube design, generating a pulsed voltage for one side, typically 75 kV, is relatively less complicated and is readily available. For example, using fast high voltage switches (based on solid state switching technology) on one power supply generator 230 of power supply 210 that is connected in series with another power supply generator 232 of power supply 210, each power supply generator 230, 232 at 80 kV and 1 kA instantaneous current provides an emission current rise time of 200 ns.

Furthermore, using pulsed voltage supply 210 provides advantages where a variable voltage magnitude is desirable, for example, for spectral content variation. The spectral content of x-ray emission from a traditional thick solid target 222 can be controlled by means of two adjustable parameters: (1) electron acceleration voltage and (2) target material composition. The high power x-ray sources currently used for medical diagnostic equipment are thick high-density high Z material targets; bremsstrahlung radiation back-scatters from the target and escapes an x-ray tube insert via a low-Z window 234. The spectrum of radiation is optionally shifted to contain higher energy radiation by using a higher accelerating voltage. The pulsed power application lends itself to control of the voltage applied across the tube 200 between cathode 204 and anode 206 from pulse to pulse. Filtration for the radiation is the same, but the pulse train contains differing pulses, some pulses having higher-energy radiation. Detectors in turn can be gated to match the emission of radiation 220. Alternatively, two different detectors are optionally used, each of which is optimized for use with different energy photons. Image subtraction, known and used in the pertinent art to heighten the effect of contrast media, can be applied with more control since the spectral content of the radiation is under some modest control in this embodiment. The short time between images also implies reduced motion-related subtraction artifacts.

Like mammography, further variation in the spectral content of the x-radiation can be achieved by using two different materials on target 222. In certain mammography target designs, two separate tracks are disposed on target 222 for electron beam bombardment. Adjustment or optimization of the x-ray output is optionally made by varying the energy of the electrons striking target 222, as well as a selection of two different materials disposed on target 222. Electron beam current can then be varied to remove or compensate for differences in x-ray yield between the two materials.

It will be recognized that fast pulse-to-pulse variations in electron beam intensity assume a certain level of technology development in fast response time cathode electron emitters. Traditionally, thermionic electron emission from a filament 236 is used to generate the electrons. A large fraction of the power dissipated in the cathode simply heats the cathode structure; cathode power supplies are larger than necessary, cathode parts are hotter than they need to be, and the waste heat must be managed through astute x-ray tube design. Field emission cathodes provide an alternative approach at generating electrons without the heating power needed in a filament-based design. Field-emitter cathodes are electron sources, in the form of arrays of microfabricated sharp tips. Field emission is used to extract the electrons without heating the cathodes. As a solid-state device, the field-emission cathodes are suitable for pulsed x-ray generation. These arrays include an original Spindt-type cathode array, in which the tips are made of molybdenum.

Electron sources, such as field emission sources of fast response time, emission current (temperature) may be switched ON and OFF between two threshold values in order to control electron generation. In the case of using other sources of electrons, a similar procedure can be used to switch electrons flow ON/OFF. The practicality of this method depends on mainly the response time of the electron sources. One exemplary method that is ideally suited to this task is possible from field emission arrays (FEA) gated with modest voltages.

In an alternative exemplary embodiment, rapid variation of emission current 218 includes gridding using a grid voltage 238. The capacitance of cathode cups is sufficiently small so that control of emission current 218 is possible on the tens to hundreds microsecond time scale. In an exemplary embodiment, gridding is used to control electron emission current. The grid electrode 240 switches from a negative potential to cut electrons flow to that of the cathode potential to let electrons flow. Since the required grid voltage 238 is in the order of few kV, fast switching can be achieved with less complication and lower cost.

Pulsed power application of high voltage electron emission for bremsstrahlung radiation emission can also be applied to thin targets that produce x-radiation in the transmission mode. The preferred embodiment would be a thin support having multiple foils of thin target material that would spin near the electron beam being used to create the x-radiation. A choice of pulse train is key to hitting the target at the proper time, synchronized to detector operation and optimized for the particular spectral content by varying the electron beam energy.

FIG. 4 shows the operating principles for one exemplary proposed method using a pulsed grid voltage discussed above. Compared to the present practice, this method reduces the energy input and finally the temperature rise in parts of the tube. With this method the thermal limitation can be raised by the efficiency improvement factor. It will be recognized that FIG. 4 exemplifies a current that is pulsed for a sub-millisecond duration, but it is contemplated that the voltage may optionally be pulsed as well. A preferred embodiment is to pulse at high frequency the current by means of quickly changing the grid voltage. It will also be noted that gridding can be used alone or in conjunction with the other methods to pulse the emission current disclosed herein.

One of the most immediate advantages of using pulsed power application with x-ray tubes will be an improvement in the efficiency of x-ray tubes. Pulsed power application will facilitate development of x-ray tubes that can handle higher power. With an increased efficiency factor, high power tubes can be more compact and patient dose management is improved by eliminating unnecessary exposure. Moreover, when the x-ray tube efficiency (power handling capability) increases, the generator power requirement reduces. This in turn means a compact and lower cost generator.

High voltage stability of x-ray tubes can be improved by applying short duration pulses and reducing the temperature of the target. Dielectric strength of insulators improves as the pulse width of the applied voltages diminish. By lowering the track (target) temperatures, the probability of spit activity (dielectric breakdown) can be reduced. It will be recognized by those skilled in the pertinent art that high voltage stability at higher current is one of the most critical x-ray tube design and performance issues.

Furthermore, when the primary pulse is generated using a pulsed high voltage supply, the use of pulsed high voltage supply brings an added advantage in improving high voltage stability of x-ray tubes. More specifically, the dielectric strength of the insulation system is in most cases dependent on the duration of the voltage application, i.e., insulators have a higher dielectric strength for short duration pulses. This means that for the same geometry or dielectric spacing, a higher voltage can be applied or for the same voltage level the spacing can be reduced.

The exemplary methods disclosed herein illustrate that by using pulsed power technology in x-ray tubes, x-ray generation is synchronized with the required x-ray output for image recording. These methods include the use of sampled x-ray detection followed with signal recovery techniques. By eliminating the unnecessary photon generation when they are not needed or have minimum effect on image quality, the average heat generated can be reduced significantly. This in turn brings an improvement to the efficiency or power handling capability of the tube.

As the speed of the detector's response time and image acquisition systems improve very rapidly, the duration for x-ray generation becomes shorter. This creates an excellent opportunity to use pulsed power technology to generate x-ray photons in the form of single pulse or multiple sampled pulses.

Depending on the response time (rise and fall time) of the x-ray detector and image acquisition time, the pulse frequency, width, and duty cycle can be optimized to produce x-ray radiation output for a required image quality. Powerful digital signal processors with fast image manipulation and processing algorithms are available to produce clear images from sampled x-ray outputs with very little or no loss of critical information.

Pulsed voltage can also be used to vary the spectral content of the x-radiation by varying the amplitude of the pulse voltage. This method of varying the spectral content with pulsed voltage can be used in applications where x-radiation of more than one spectral content are required.

In conclusion, the method and apparatus using pulsed power application for generating pulsed emission current for producing similarly pulsed x-ray radiation results in improved efficiency in x-ray tubes; improved patient dose management; improved high voltage stability; and provides a means of varying spectral content.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A pulsed power application system for an x-ray tube comprising:
an x-ray tube having an anode and cathode; and
a power supply adapted to provide an anode-to-cathode gap voltage, wherein said gap voltage is pulsed for a sub-millisecond duration resulting in a pulsed x-ray radiation.

2. The pulsed power application system of claim 1, wherein said gap voltage is pulsed by pulsing the extraction voltage of said power supply.

3. The pulsed power application system of claim 1, wherein the x-ray tube is bipolar and said anode is connected to a positive terminal of a first power supply and said cathode is connected to a negative terminal of a second power supply, remaining terminals of said first and second power supply are referenced to ground.

4. The pulsed power application system of claim 1, wherein said anode is referenced to ground potential and said cathode is connected to a negative terminal of a second power supply.

5. The pulsed power application system of claim 1, further includes a grid voltage applied to a grid terminal proximate said anode and cathode, said grid voltage is applied for a sub-millisecond duration to control electron emission current.

6. The pulsed power application system of claim 1, wherein said cathode includes one of a switchable electron source and a switchable filament.

7. The pulsed power application system of claim 5, wherein said cathode is in operable communication with one of a switchable electron source and a switchable filament.

8. The pulsed power application system of claim 7, wherein said electron source includes a field emission array (FEA).

9. The pulsed power application system of claim 8, wherein said field emission array (FEA) includes a Spindt-type field emission array.

10. An x-ray tube adapted to generate pulsed x-ray radiation comprising:
a frame;
an anode disposed in said frame;
a cathode corresponding with said anode disposed in said frame; and
a power supply adapted to provide an anode-to-cathode gap voltage, wherein said gap voltage is pulsed for a sub-millisecond duration resulting in a pulsed x-ray radiation.

11. The x-ray tube of claim 10, wherein said gap voltage is pulsed by pulsing the extraction voltage of said power supply.

12. The x-ray tube of claim 10, wherein said power supply includes a positive terminal in electrical communication with said anode and a negative terminal in electrical communication with said cathode, wherein said power supply generates a pulsed emission current resulting in the pulsed x-ray radiation from said anode.

13. The x-ray tube of claim 10, wherein the x-ray tube is bipolar and said anode is connected to a positive terminal of a first power supply and said cathode is connected to a negative terminal of a second power supply, remaining terminals of said first and second power supply are referenced to ground.

14. The x-ray tube of claim 10, further includes a grid voltage applied to a grid terminal proximate said anode and cathode, said grid voltage is applied to control electron emission current.

15. The x-ray tube of claim 14, wherein said cathode includes one of a switchable electron source and a switchable filament.

16. The x-ray tube of claim 10, wherein said cathode is in operable communication with one of a switchable electron source and a switchable filament.

17. The x-ray tube of claim 16, wherein said electron source includes a field emission array (FEA).

18. The x-ray tube of claim 17, wherein said field emission array (FEA) includes a Spindt-type field emission array.

19. A method to improve the efficiency of operation in x-ray tubes, the method comprising:
connecting a high voltage supply to the x-ray tube having an anode and a cathode disposed in the x-ray tube to provide a gap voltage therebetween;
pulsing said gap voltage for a sub-millisecond duration; and
generating a pulsed x-ray radiation from said anode.

20. A method to control the spectral content of x-ray emission from an x-ray tube, the method comprising:
connecting a high voltage supply to the x-ray tube having an anode and a cathode disposed in the x-ray tube to provide a gap voltage therebetween;
disposing at least one target material on said anode;
pulsing said gap voltage for a sub-millisecond duration;
generating a pulsed x-ray radiation from said anode; and
detecting said pulsed x-ray radiation with a detector corresponding to an energy level of the generated pulsed x-ray radiation.

21. The method of claim 20, wherein said pulsing said gap voltage includes controlling the amplitude from pulse-to-pulse, said control providing different energy radiation for variation in the spectral content.

22. The method of claim 21, wherein said detector is gated to match emission of said x-ray radiation.

23. The method of claim 21, wherein said at least one target material includes a plurality of target materials, each target material of said plurality of target materials corresponding with said energy level of the generated pulsed x-ray radiation.

24. The method of claim 21, wherein two detectors are employed, each detector of said two corresponding with said energy level of the generated pulsed x-ray radiation.

25. A pulsed power application system for an x-ray tube comprising:
an x-ray tube having an anode and cathode;
a power supply adapted to provide an anode-to-cathode gap voltage; and
a pulsing means for pulsing said gap voltage for a sub-millisecond duration resulting in a pulsed x-ray radiation.

26. The pulsed power application system of claim 25 wherein said pulsing means includes at least one of, and includes combinations of at least one of:
pulsing the extraction voltage of said power supply;
applying a grid voltage to control electron emission current; and
switching one of a switchable electron source and a switchable filament in operable communication with the cathode.
